(19) United States
(12) Patent Application Publication
(10) Pub. No.: US 2025/0182097 A1
(43) Pub. Date: Jun. 5, 2025

(54) TARGETED HEURISTIC RULE GENERATION TOOLS

(71) Applicant: Stripe, Inc., South San Francisco, CA (US)

(72) Inventors: Anthony PIANTA, Washington, DC (US); Ariel SAGALOVSKY, Los Angelos, CA (US); Chiranth HEGDE, Seattle, WA (US)

(21) Appl. No.: 18/529,956

(22) Filed: Dec. 5, 2023

(51) Int. Cl. G06Q 20/38; G06F 3/04847; G06Q 20/40

(52) U.S. Cl. CPC G06Q 20/382; G06F 3/04847; G06Q 20/4016

(57) ABSTRACT

This disclosure describes targeted heuristic rule generation tools for fraudulent activity. More specifically, embodiments are directed to a server system for implementing a transaction processing rule (TPR) generator that facilitates generation of transaction processing rules. In many embodiments, these transaction processing rules may be directed to blocking (or allowing) transactions in scenarios that are generally uncommon, but disproportionately affect some entities (e.g., merchants). For example, some merchants may be particularly vulnerable to certain types of fraud that a majority of merchants are not vulnerable to, such as repetitive order and refund fraud schemes. Embodiments may include various components that operate to assist a user (e.g., a merchant) in creating and implementing transaction processing rules tailored to unique or uncommon scenarios they may face.

### CROSS-REFERENCE TO RELATED APPLICATIONS

The present application is related to U.S. patent application Ser. No. 17/894,580, entitled RANDOM FOREST RULE GENERATOR, filed on Aug. 24, 2022, which is incorporated herein by reference.

### FIELD OF DISCLOSURE

This disclosure is related generally to targeted heuristic rules and more particularly to targeted heuristic rule generation tools for fraudulent activity.

### BACKGROUND

Fraud generally includes wrongful or criminal deception intended to result in financial or personal gain. Fraud is a major problem for many commerce entities, such as merchants, due to the considerable monetary and time resources it can cost. Accordingly, detection and prevention of fraud is an objective of many commerce entities. However, techniques to detect and prevent fraud must also seek to prevent identifying legitimate interactions as fraudulent.

To prevent fraud, such as when a proffered payment is made with a stolen card number, a card number from an expired card, a spoofed card, etc., the commerce system may perform fraud detection for the transactions. Such fraud detection can include attempting to determine, based on parameters associated with a transaction, whether there is a likelihood that the transaction is fraudulent. For example, whether a card number is associated with past fraudulent transactions, whether the transaction amount or purchase location is a-typical for the card number, what IP address a remote transaction has originated from, etc. Thus, the fraud detection seeks to determine when one or more factors associated with the transaction indicate fraud, such as by employing machine learning techniques to analyze transaction data. Data regarding various aspects of a transaction may be generated, collected, and/or utilized, such as during processing a transaction. For example, applying rules for determining whether to allow or block processing of a transaction can be based on this data.

### BRIEF SUMMARY

Processes, apparatuses, machines, and articles of manufacture for generating rules for processing transactions are described. It will be appreciated that the embodiments may be combined in any number of ways without departing from the scope of this disclosure.

Example methods, such as computer-implemented methods for generating transaction processing rules are described herein. An example method may include identifying, by a server system, a set of transactions, wherein each transaction in the set of transactions includes a set of values for a set of attributes and a portion of the set of transactions include a target label; processing, by a machine learning (ML) model of the server system, the set of transactions to determine one or more predictive attributes in the set of attributes, wherein the one or more predictive attributes are indicative of transactions in the portion of the set of transactions that include the target label; identifying, by the server system, a selected predictive attribute of the one or more predictive attributes based on first user input; identifying, by the server system, a selected value for the selected predictive attribute based on second user input; generating, by the server system, a heuristic rule for transactions based on the selected predictive attribute, wherein the heuristic rule utilizes the selected value for the selected predictive attribute as a threshold value for determining whether to block a particular transaction; and applying, by the server system, the heuristic rule to the set of transactions to determine a set of blocked transactions and a set of unblocked transactions.

Example non-transitory computer-readable media are disclosed herein. An example non-transitory computer-readable storage medium includes instructions that, when executed by a processor, cause the processor to perform operations for generating transaction processing rules, the operations comprising: identifying, by a server system, a set of transactions, wherein each transaction in the set of transactions includes a set of values for a set of attributes and a portion of the set of transactions include a target label; processing, by a machine learning (ML) model of the server system, the set of transactions to determine one or more predictive attributes in the set of attributes, wherein the one or more predictive attributes are indicative of transactions in the portion of the set of transactions that include the target label; identifying, by the server system, a selected predictive attribute of the one or more predictive attributes based on first user input; identifying, by the server system, a selected value for the selected predictive attribute based on second user input; generating, by the server system, a heuristic rule for transactions based on the selected predictive attribute, wherein the heuristic rule utilizes the selected value for the selected predictive attribute as a threshold value for determining whether to block a particular transaction; and applying, by the server system, the heuristic rule to the set of transactions to determine a set of blocked transactions and a set of unblocked transactions.

Example server computer systems are disclosed herein. An example server computer system for generating transaction processing rules comprises a memory and a processor coupled to the memory configured to: identify, by a server system, a set of transactions, wherein each transaction in the set of transactions includes a set of values for a set of attributes and a portion of the set of transactions include a target label; process, by a machine learning (ML) model of the server system, the set of transactions to determine one or more predictive attributes in the set of attributes, wherein the one or more predictive attributes are indicative of transactions in the portion of the set of transactions that include the target label; identify, by the server system, a selected predictive attribute of the one or more predictive attributes based on first user input; identify, by the server system, a selected value for the selected predictive attribute based on second user input; generate, by the server system, a heuristic rule for transactions based on the selected predictive attribute, wherein the heuristic rule utilizes the selected value for the selected predictive attribute as a threshold value for determining whether to block a particular transaction; and apply, by the server system, the heuristic rule to the set of transactions to determine a set of blocked transactions and a set of unblocked transactions.

Generating rules for transaction processing in this manner allows for customized rules for specific use cases to be created and tested in a quick and efficient manner without requiring expert guidance (e.g., from a data scientist). In turn, this allows for new rules directed to new scenarios (e.g., of fraudulent behavior) to be rapidly implemented to minimize negative outcomes (e.g., fraudulent purchases) without introducing unwanted complexity and excessive resource demands.

Other processes, machines, and articles of manufacture are also described herein, which may be combined in any number of ways, such as with the embodiments of the brief summary, without departing from the scope of this disclosure.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

To easily identify the discussion of any particular element or act, the most significant digit or digits in a reference number refer to the figure number in which that element is first introduced.

FIG. 1 illustrates a block diagram of an exemplary system architecture for generating rules for transaction processing according to some embodiments.

FIG. 2 illustrates various aspects of a server system including a transaction processing rule (TPR) generator according to some embodiments.

FIG. 3 illustrates an exemplary process flow for manipulating transaction metadata according to some embodiments.

FIG. 4 illustrates an exemplary process flow for transaction processing rule generation according to some embodiments.

FIG. 5 illustrates various aspects of an exemplary graphical user interface (GUI) view for configuring parameters for transaction processing rule generation according to some embodiments.

FIG. 6 illustrates various aspects of an exemplary GUI view for configuring attribute values for a transaction processing rule according to some embodiments.

FIG. 7 illustrates a logic flow of an exemplary method for generating a transaction processing rule according to some embodiments.

FIG. 8 is one embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “determining”, “initializing”, “generating”, “populating”, “updating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Generally, this disclosure describes targeted heuristic rule generation tools for fraudulent activity. More specifically, embodiments are directed to a server system for implementing a transaction processing rule (TPR) generator that facilitates generation of transaction processing rules. In many embodiments, these transaction processing rules may be directed to blocking (or allowing) transactions in scenarios that are generally uncommon, but disproportionately affect some entities (e.g., merchants). For example, some merchants may be particularly vulnerable to certain types of fraud that a majority of merchants are not vulnerable to, such as repetitive order and refund fraud schemes. Embodiments may include various components that operate to assist a user (e.g., a merchant) in creating and implementing transaction processing rules tailored to unique or uncommon scenarios they may face. These and other embodiments are described and claimed.

Existing techniques for generating transaction processing rules, such as for blocking fraudulent transactions, require excessive resource and expertise. For example, a data scientist is typically needs to spend many hours to extract knowledge and insights from noisy, structured, and unstructured data regarding transactions. Additionally, computer programmers may be required to create and implement rules (e.g., a heuristic rule) for processing future transactions based on the knowledge and insights extracted by the data scientist. However, such manual processes that utilize data scientist and computer programmers are exceedingly expensive and impractical in many scenarios. For example, many merchants face unique fraud scenarios, but are unable to afford customized transaction processing rules designed to block the unique fraud scenarios they face. Adding further complexity and expense, fraud tactics are constantly changing and evolving, requiring custom transaction processing rules to be periodically updated and/or replaced. Thus, many merchants are forced to rely on generic transaction processing rules that are not tailored for their specific scenarios. Generic rules are designed to block transactions in a wide variety of illegitimate scenarios while still allowing transactions in a wide variety of legitimate scenarios. This results in generic rules having suboptimal performance, especially regarding various scenarios that certain merchants may routinely encounter while a majority of merchants rarely or never encounter. These limitations can drastically reduce the attainability and usability of custom or targeted transaction processing rules, contributing to systems that are ineffective, excessively reliance on manual processes, and have unnecessarily high resource requirements, resulting in ineffective systems, devices, and techniques with limited capabilities.

Accordingly, many embodiments disclosed herein provide resource-efficient and scalable techniques to create and implement transaction processing rules without requiring expert guidance. In several embodiments, a TPR generator may be utilized to process transaction data to identify attributes that are useful in identify a specific set of transactions. In several such embodiments, one or more of these attributes may be utilized to create transaction processing rules directed to blocking (or allowing) future transactions that correspond to the specific set of transactions. For example, a merchant may be able to label specific transactions are fraudulent, one or more components of the TPR generator may then determine attributes that can be utilized to predict the labelled transactions and one or more of the attributes may be selected to use in generating a transaction processing rule. Further, the TPR generator may assist users in determining specific values or value ranges for the attributes that are particularly useful in identifying the labelled transactions. The one or more of the determined attributes, values, and/or ranges may then be utilized to generate and implement a transaction processing rule targeted to blocking future instances of the labelled transactions.

In these and other ways, components/techniques described herein provide many technical advantages. For instance, the computer-based techniques of the current disclosure increase the accessibility, practicality, adaptability, and availability of transaction processing rules, thereby improving the functioning of a server systems for generating transaction processing rules as compared to conventional approaches. Additionally, the computer-based techniques of the current disclosure can provide users with a valuable tool for reducing fraudulent transactions and/or false positives (e.g., blocking a legitimate transactions as fraudulent), resulting in better realization and fewer losses. Accordingly, embodiments disclosed herein can be practically utilized to improve the functioning of a computer and/or to improve a variety of technical fields including transaction processing rule generation, fraud detection, false positives, transaction processing, and/or user experience (e.g., merchant capabilities).

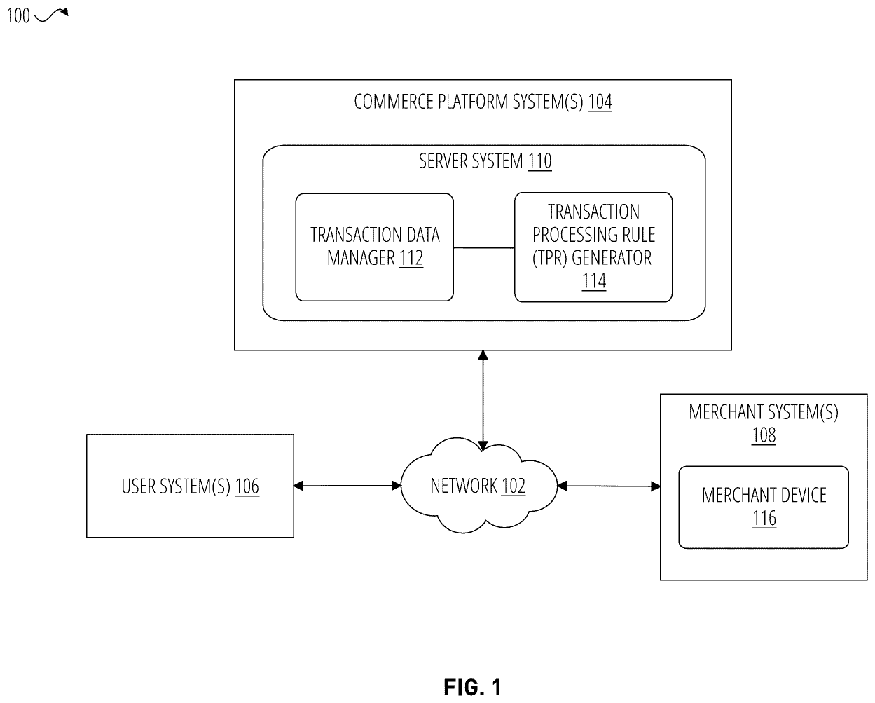

FIG. 1 is a block diagram of an exemplary system architecture 100 for generating rules for transaction processing according to some embodiments. In one embodiment, the system 100 includes one or more commerce platform systems 104, one or more merchant systems 108, and one or more user systems 106. In one embodiment, one or more systems (e.g., systems 106 and 108) may be mobile computing devices, such as a smartphone, tablet computer, smartwatch, etc., as well computer systems, such as a desktop computer system, laptop computer system, server computer systems, etc. The commerce platform systems 104 and merchant systems 108 may also be one or more computing devices, such as one or more server computer systems, desktop computer systems, etc. Furthermore, there may be any number of user systems 106 and/or merchant systems 108 utilizing the services of the commerce platform systems 104. However, to avoid obscuring the present description, only one commerce platform system 104, user system 106, and merchant system 108 are generally illustrated and described.

Furthermore, it should be appreciated that the embodiments discussed herein may be utilized by a plurality of different types of systems, such as other commerce platform system(s) including payment processing systems, card authorization systems, banks, and other systems seeking to identify and detect fraud during transactions. Furthermore, any system seeking to handle transaction-related data may use and/or extend the techniques discussed herein to improve efficiency, scalability, and/or availability of transaction-related data. However, to avoid obscuring the embodiments discussed herein, transaction processing rule generation (e.g., via a TPR generator 114), is discussed to illustrate and describe the embodiments of the present invention, and is not intended to limit the application of the techniques described herein to other systems in which transaction-related data handling could be used.

The commerce platform system 104, merchant system 108, and user system 106 may be coupled to a network 102 and communicate with one another using any of the standard protocols for the exchange of information, including secure communication protocols. In one embodiment, one or more of the commerce platform system 104, merchant system 108, and user system 106 may run on one Local Area Network (LAN) and may be incorporated into the same physical or logical system, or different physical or logical systems. Alternatively, the commerce platform system 104, merchant system 108, and user system 106 may reside on different LANs, wide area networks, cellular telephone networks, etc. that may be coupled together via the Internet but separated by firewalls, routers, and/or other network devices. In one embodiment, commerce platform system 104 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, commerce platform system 104 provides financial processing services to one or more merchants, such as to merchant system 108 and/or user system 106 that act as an agent of merchant system 108. For example, commerce platform system 104 may manage merchant accounts held at the commerce platform, run financial transactions from user system 106 performed on behalf of a merchant, clear transactions, performing payouts to merchant and/or merchant agents, manage merchant and/or agent accounts held at the commerce platform system 104, as well as other services typically associated with commerce platforms systems such as, for example, STRIPE™.

To generate transaction processing rules, in embodiments, commerce platform system 104 utilize a server system 110 including one or more of a transaction data manager 112 and a TPR generator 114. As will be discussed in greater detail below, the TPR generator 114 may utilize transaction-related data retrieved from the transaction data manager 112 and efficiently process the transaction-related data to generate transaction processing rules in a customizable, intuitive, and interactive manner. In many embodiments, the TPR generator 114 may receive input from and communicate output to a merchant device 116 during generation of a transaction processing rule. In the illustrated embodiment, the merchant device 116 is included in the merchant system 108. However, in additional, or alternative embodiment, the merchant device 116 may be included in user system 106 and/or commerce platform system 104 without departing from the scope of this disclosure. In some examples, the transaction data manager 112 and TPR generator 114 operate substantially independently from each other. Thus, one or more embodiments described herein generally decouple capturing and storing of transaction-related data (which may be performed by transaction data manager 112) and generation of transaction processing rules (which may be performed by TPR generator 114) to provide improved generation of transaction processing rules.

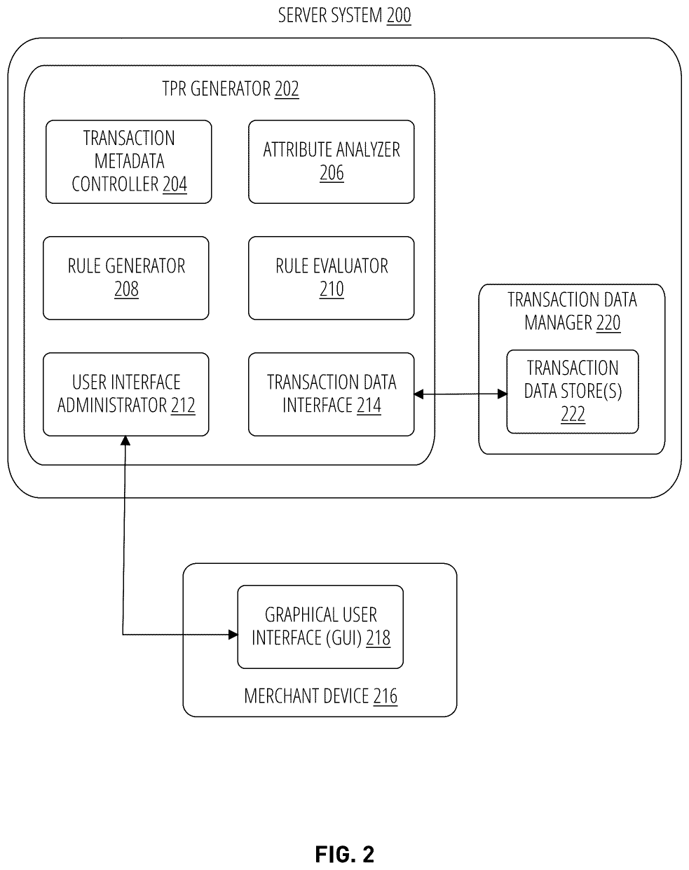

FIG. 2 illustrates various aspects of a server system 200 including a TPR generator 202 according to some embodiments. In the illustrated embodiment, the server system 200 includes the TPR generator 202 and a transaction data manager 220. The TPR generator 202 is communicatively coupled to a merchant device 216 and the transaction data manager 220. The TPR generator 202 includes an attribute analyzer 206, a transaction metadata controller 204, a rule generator 208, a rule evaluator 210, a user interface administrator 212, and a transaction data interface 214. The merchant device 216 includes a GUI 218 that is communicatively couplable to the TPR generator 202 via user interface administrator 212 and the transaction data manager 220 includes one or more transaction data stores 222 that are communicatively couplable to the TPR generator 202 via transaction data interface 214. In various embodiments, the TPR generator 202 may utilize input received via the GUI 218 of merchant device 216 combined with analysis of transaction-related data retrieved from transaction data store 222 of transaction data manager 220 to create and implement transaction processing rules tailored to the specific needs of a merchant. It will be appreciated that one or more components of FIG. 2 may be the same or similar to one or more other components disclosed herein. For example, TPR generator 202 may be the same or similar to TPR generator 114. In another example, transaction data manager 220 may be the same or similar to server system 110. Further, aspects discussed with respect to various components in FIG. 2 may be implemented by one or more other components from one or more other embodiments without departing from the scope of this disclosure. For example, transaction data manager 220 and/or transaction data store 222 may be implemented by components external to the server system 200, such as components of commerce platform system 104 without departing from the scope of this disclosure. Embodiments are not limited in this context.

Generally, the components of TPR generator 202 implement techniques for generating rules for transaction processing. These transaction processing rules may be directed to blocking (or allowing) transactions in scenarios that are generally uncommon, but disproportionately affect some entities (e.g., merchants). For example, some merchants may be particularly vulnerable to certain types of fraud that a majority of merchants are not vulnerable to, such as repetitive order and refund fraud schemes. Further, these components may operate to assist a user (e.g., a merchant) in creating, evaluating, and implementing transaction processing rules tailored to unique or uncommon scenarios they may face, such as via GUI 218 of merchant device 216.

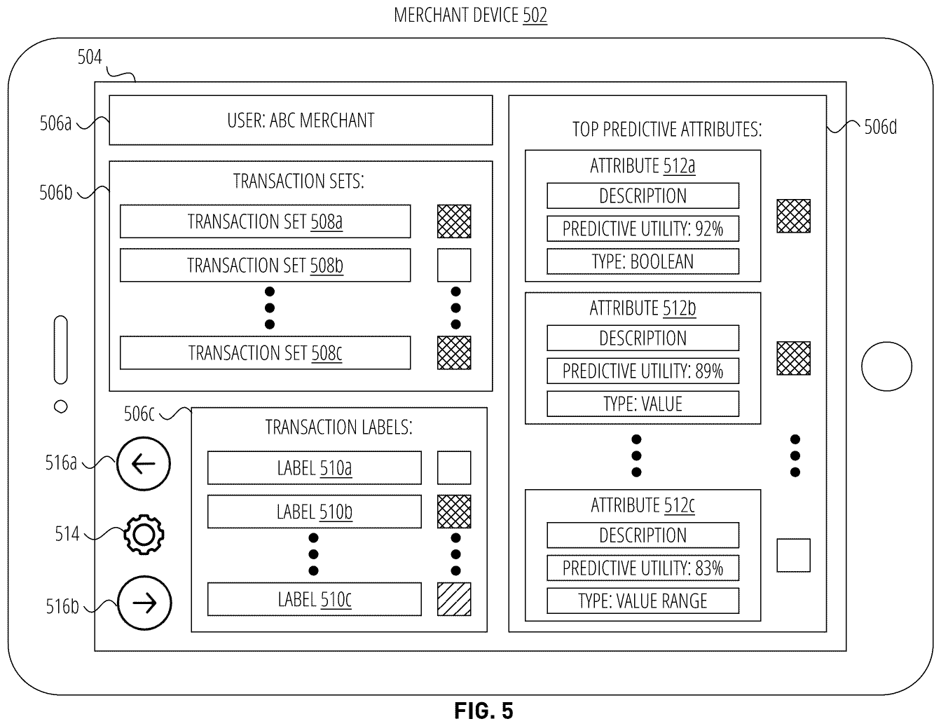

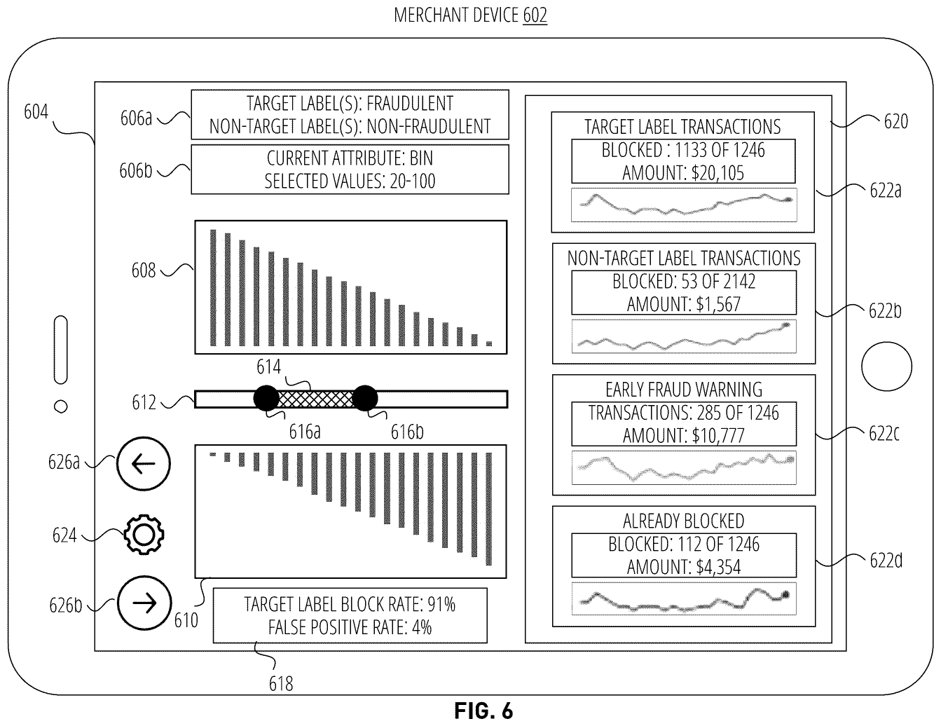

As shown in FIG. 2, the TPR generator 202 includes transaction metadata controller 204, attribute analyzer 206, rule generator 208, rule evaluator 210, user interface administrator 212, and transaction data interface 214. The user interface administrator 212 may facilitate interaction between the TPR generator 202 and the GUI 218 of merchant device 216. Accordingly, in various embodiments, the user interface administrator 212 may generate and transmit data that configures the GUI 218 to render information relevant to the transaction rule generation process as well as received input from a user relevant to the transaction rule generation process. For example, user interface administrator 212 may generate data based on output of rule evaluator 210 to cause GUI 218 to display charts based on the output of rule evaluator 210 (see e.g., target label chart 608 and non-target label chart 610 of FIG. 6). In some embodiments, a user may configure settings for and contents of the GUI 218 via the user interface administrator 212 (e.g., the contents of GUI view 504 of FIG. 5 and/or the contents of GUI view 604 of FIG. 6). The transaction data interface 214 may facilitate retrieval, identification, and/or storage of transaction-related data utilized by the TPR generator 202. Accordingly, in many embodiments, the transaction data interface 214 may interact with transaction data manager 220 to retrieve, identify, and/or store transaction-related data from transaction data store 222 in support of generation of transaction processing rules by TPR generator 202.

The transaction metadata controller 204 may generally operate to facilitate creation, interaction, and manipulation of transaction-related data. For example, transaction metadata controller 204 may enable various labels (e.g., target labels and/or non-target labels) to be applied to different transactions, such as based on user input. In some embodiments, these labels may be utilized to identify a particular set of transactions that a transaction processing rule will be directed to. For example, a user may utilize transaction metadata controller 204 to label transactions that were ultimately determined to be fraudulent despite being originally allowed. In an additional, or alternative, example, a user may utilize transaction metadata controller 204 to label transactions that were originally blocked despite being ultimately determined as legitimate.

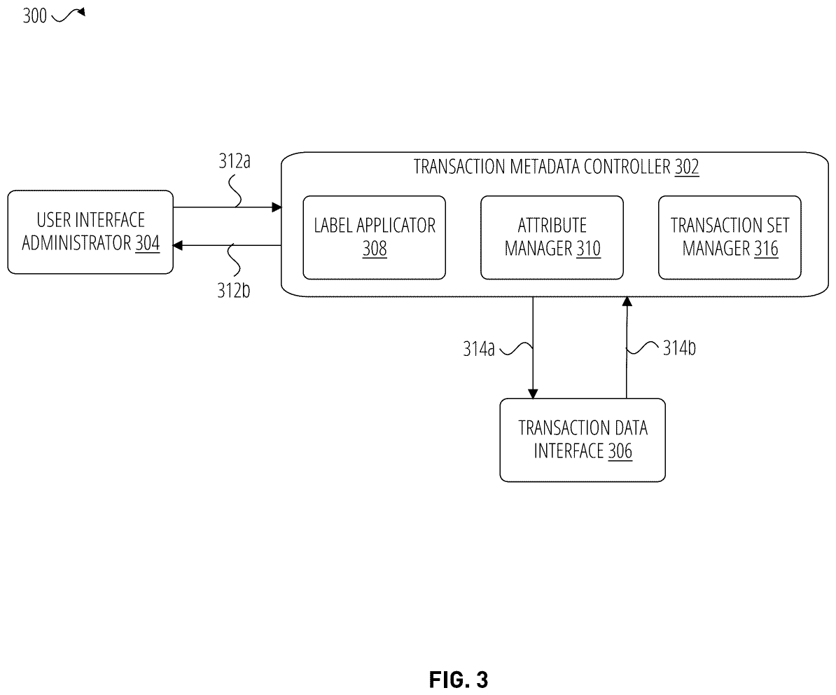

Further, transaction metadata controller 204 may facilitate incorporation of one or more user-defined attributes to existing attributes of transactions. For example, merchants may add attributes to transactions related to interactions with a website of a merchant, such as page views, product views, time spent on various parts of the website, and the like. Still further, the transaction metadata controller 204 may enable users to create various groupings or sets of transactions. In various embodiments, these groupings or sets of transactions may be utilized to generate a transaction processing rules. For example, a merchant may operate a plurality of websites, but only one of the websites face a certain type of fraudulent activity that the merchant desires to stop. In such examples, the merchant may utilize transaction metadata controller 204 to create a set of transactions that only include transactions associated with the website that faces the certain type of fraudulent activity. Various aspects of transaction metadata managers disclosed hereby (e.g., transaction metadata controller 204) will be described in more detail below, such as with respect to FIG. 3.

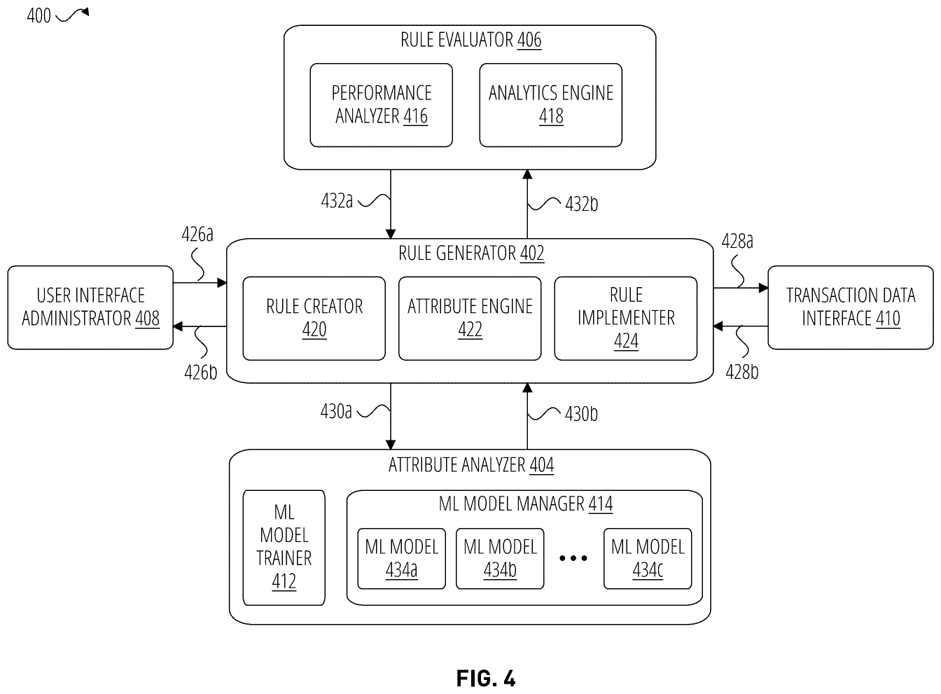

The attribute analyzer 206 may generally operate to identify one or more predictive attributes from a set of attributes corresponding to a set of transactions. In many embodiments, the one or more predictive attributes may include one or more attributes in the set of attributes that are determined to be indicative of transactions that include a particular label. For example, if a portion of a set of transactions are labeled as fraudulent, the attribute analyzer 206 may utilize one or more machine learning techniques to identify the attributes in the set of attributes that are useful in identifying the transactions in the portion of the set of transactions that are labeled as fraudulent. Various aspects of the attributes and attribute analyzers disclosed hereby (e.g., attribute analyzer 206) will be described in more detail below, such as with respect to FIG. 4.

The rule generator 208 may generally operate to generate a transaction processing rule based on transactions, attributes, labels, user input, and the like. In many embodiments, the rule generator 208 may interact with other components of the TPR generator 202 during the process of generating a rule. For example, rule generator 208 may interact with attribute analyzer 206 to determine predictive attributes. In another example, rule generator 208 may interact with transaction metadata controller 204 to determine a set of transactions, attributes for the set of transactions, and/or labels for transactions in the set of transactions. In various embodiments, the rule generator 208 may generate a heuristic transaction processing rule based on based on transactions, attributes, labels, and user input (e.g., selection of attributes and/or values for the selected attributes). For example, rule generator 208 may generate a heuristic rule that blocks transactions (or allows transactions) that include one or more attributes with one or more values (or ranges of values or sets of discrete values). Various aspects of rule generators disclosed hereby (e.g., rule generator 208) will be described in more detail below, such as with respect to FIG. 4.

The rule evaluator 210 may generally operate to analyze performance of a transaction processing rule, such as a transaction processing rule created by rule generator 208. In various embodiments, the rule evaluator 210 may support testing of transaction processing rules, such as on historical transactions and/or the set of transactions utilized to generate the rule. Additionally, or alternatively, the rule evaluator 210 may determine various metrics that characterize performance of a transaction processing rule. For example, the rule evaluator 210 may determine blocked transactions, unblocked transactions, previously blocked transactions, previously unblocked transactions, blocking rates, false positive rates, and the like. Various aspects of rule evaluators disclosed hereby (e.g., rule evaluator 210) will be described in more detail below, such as with respect to FIG. 4.

FIG. 3 illustrates an exemplary process flow 300 for manipulating transaction metadata according to some embodiments. The illustrated embodiment includes a user interface administrator 304, a transaction metadata controller 302, and a transaction data interface 306. The transaction metadata controller 302 may include a label applicator 308, an attribute manager 310, and a transaction set manager 316. In various embodiments, the components of transaction metadata controller 302 may enable a user to interact with transaction-related data, such as by adding labels, adding custom attributes, and/or creating groupings of transactions. It will be appreciated that one or more components of FIG. 3 may be the same or similar to one or more other components disclosed herein. For example, one or more of transaction metadata controller 302, user interface administrator 304, and transaction data interface 306 may be the same or similar to one or more of transaction metadata controller 204, user interface administrator 212, and transaction data interface 214, respectively. Further, aspects discussed with respect to various components in FIG. 3 may be implemented by one or more other components from one or more other embodiments without departing from the scope of this disclosure. For example, transaction set manager 316 may be implemented by transaction data manager 220 without departing from the scope of this disclosure. Embodiments are not limited in this context.

The components of FIG. 3 may generally be utilized to configure transaction-related data (i.e., transaction metadata) for generation of transaction processing rules. These operations may be coordinated by the transaction metadata controller 302, which is communicatively coupled to the user interface administrator 304 and the transaction data interface 306. The transaction metadata controller 302 may operate to facilitate creation, interaction, and manipulation of transaction-related data (i.e., transaction metadata). For example, these operations may include adding labels to transactions (e.g., via label applicator 308), adding attributes to transactions (e.g., via attribute manager 310), and creating sets of transactions (e.g., via transaction set manager 316). Many of these operations may be based on one or more inputs 312a from a user received via user interface administrator 304. Additionally, many of these operations may produce one or more outputs 312b that are presented, or used to generate data to configure a user interface to present data, to users, such as via a GUI.

Further, many of these operations may cause the transaction metadata controller 302 to generate one or more inputs 314a for the transaction data interface 306 and, in response, receive one or more outputs 314b from the transaction data interface 306. For example, a query may be provided as an input to the transaction data interface 306. In response, the transaction data interface 306 may utilize the query to retrieve one or more transactions from one or more transaction data store. In another example, transaction data interface 306 may be utilized to update transaction data stores with updated or additional values, such as labels, user-defined attributes, and transaction groupings. In some embodiments, the transaction metadata controller 302 may automatically retrieve one or more transactions via the transaction data interface 306 in response to a user logging in. For example, transactions associated with a merchant may be automatically retrieved in response to a user associated with the merchant logging in to the system. In various embodiments, the transaction metadata controller 302 may index transactions associated with a entity corresponding to a user and allow the user to select which transactions to retrieve. In some embodiments, transaction metadata controller 302 may prevent various transaction-related data from being accessed or viewed by a user, such as by implementing a privacy policy. For example, some attributes may be based on transactions for a plurality of merchants. However, displaying attributes based on transactions for a plurality of merchants may violate a privacy policy implemented by the transaction metadata controller 302.

The label applicator 308 may generally operate to facilitate labeling of transactions. For example, a user may select transactions to apply one or more labels to. The labels may be defined by the user and/or be predefined. In several embodiments, label applicator 308 may label certain transactions a fraudulent and other transactions a legitimate, such as based on one or more of input 312a. In several such embodiments, label applicator 308 may label transactions with a specific type of fraud, such as repeat purchase and return fraud. In some embodiments, label applicator 308 may facilitate labeling groups of transactions. For example, label applicator 308 may label all transactions having a specific BIN or IP address as fraudulent. As discussed in more detail below, these labels may be utilized to indicate which transactions should be targeted or not targeted when generating a transaction processing rule. For example, transactions labeled as fraudulent may later be identified as a target label for generating a transaction processing rule.

The attribute manager 310 may generally operate to facilitate incorporation of one or more user-defined attributes to existing attributes of transactions. More generally, one or more attributes may be added that are not currently included. In many embodiments, attributes may be added that are based on data that is not available to the server system (e.g., server system 110) or commerce platform system (e.g., commerce platform system 104), such as some data that is collected by merchant systems (e.g., merchant system 108). For example, merchants may add attributes to transactions related to interactions with a website of a merchant, such as page views, product views, time spent on various parts of the website, contents of a shopping cart, method used for access (e.g., browser type, application, etc.), and the like. In a further example, a merchant may determine that time spent checking out on the website (or overall time spent on the website) is a useful attribute because when time spent checking out on the website is a short value (e.g., <10 seconds) it may be indicative of an automated checkout system. Further, an automated checkout system may be indicative of fraudulent activity because it enables the malicious actor to perform a large number of check out processes in a fast and automated manner rather than manually performing the checkout processes. This can be indicative of fraudulent activity because legitimate users do not have the need to perform a large number of check out processes in a fast and automated manner. In some embodiments, the user-defined attributes may be imported via user interface administrator 304 as one or more of input 312a. In other embodiments, a transaction data manager (e.g., transaction data manager 220) may be configured to facilitate importation of user-defined attributes.

The transaction set manager 316 may generally operate to enable users to create various groupings or sets of transactions. In various embodiments, these groupings or sets of transactions may be utilized to generate a transaction processing rules. For example, a merchant may operate a plurality of websites, but only one of the websites face a certain type of fraudulent activity that the merchant desires to stop. In such examples, the merchant may utilize transaction set manager 316 to create a set of transactions that only include transactions associated with the website that faces the certain type of fraudulent activity. In another example, transaction set manager 316 may be utilized to create a set of transactions corresponding to a specific geographical region.

FIG. 4 illustrates an exemplary process flow 400 for transaction processing rule generation according to some embodiments. The illustrated embodiment includes an attribute analyzer 404, a rule generator 402, a rule evaluator 406, a user interface administrator 408, and a transaction data interface 410. The attribute analyzer 404 may include a machine learning (ML) model trainer 412 and an ML model manager 414. The rule generator 402 may include a rule creator 420, an attribute engine 422, and a rule implementer 424. The rule evaluator 406 may include a performance analyzer 416 and an analytics engine 418. In various embodiments, the components of the attribute analyzer 404, rule generator 402, and rule evaluator 406 may operate in conjunction to enable a user to create and implement transaction processing rules. It will be appreciated that one or more components of FIG. 4 may be the same or similar to one or more other components disclosed herein. For example, one or more of attribute analyzer 404, rule generator 402, and rule evaluator 406 may be the same or similar to one or more of attribute analyzer 206, rule generator 208, and rule evaluator 210, respectively. In another example, user interface administrator 408 and/or transaction data interface 410 may be the same or similar to user interface administrator 304 and/or transaction data interface 306, respectively. Further, aspects discussed with respect to various components in FIG. 4 may be implemented by one or more other components from one or more other embodiments without departing from the scope of this disclosure. For example, attribute engine 422 may be implemented by attribute analyzer 404 without departing from the scope of this disclosure. Embodiments are not limited in this context.

The components of FIG. 4 may generally be used to configure generation of a transaction processing rule and evaluate performance of the generated transaction processing rule. These operations may be coordinated by the rule generator 402, which is communicatively coupled to the attribute analyzer 404, the rule evaluator 406, the user interface administrator 408, and the transaction data interface 410. As discussed in more detail below, many of these operations may be based on one or more inputs and one or more outputs exchanged between the different components. For example, one or more inputs 426a may be received from a user via user interface administrator 408. Additionally, many operations may produce one or more outputs 426b that are presented, or used to generate data to configure a user interface to present data, to users, such as via a GUI. These inputs and outputs may be the same or similar to those described with respect to inputs 312a, outputs 312b, and user interface administrator 304 of FIG. 3. Further, many of these operations may cause the transaction data interface 410 to generate one or more inputs 428a for the transaction data interface 410 and, in response, receive one or more outputs 428b from the transaction data interface 410. These inputs and outputs may be the same or similar to those described with respect to inputs 314a, output 314b, and transaction data interface 306 of FIG. 3.

The rule generator 402 may generally operate to generate, evaluate, and/or implement a transaction processing rule based on transactions, attributes, labels, user input, and the like. In the illustrated embodiment, the rule generator 402 includes a rule creator 420, an attribute engine 422, and a rule implementer 424. In various embodiments, the rule creator 420 of rule generator 402 may generate a heuristic transaction processing rule based on based on transactions, attributes, labels, and user input (e.g., selection of attributes and/or values for the selected attributes). In various such embodiments, the rule creator 420 may generate a heuristic rule that blocks transactions (or allows transactions) that include one or more attributes with one or more values (or ranges of values or sets of discrete values). As described in more detail below, in many embodiments, the components of rule generator 402 may interact with each other and/or one or more of attribute analyzer 404, rule evaluator 406, user interface administrator 408, and transaction data interface 410 during the process of generating, evaluating, and/or implementing a rule. For example, attribute engine 422 of rule generator 402 may send one or more inputs 430a and receive one or more outputs 430b from attribute analyzer 404 to determine predictive attributes. In another example, rule creator 420 of rule generator 402 may send one or more inputs 432a and receive one or more outputs 432b from rule evaluator 406 to evaluate performance and/or generate metrics based on the performance of a transaction processing rule.

In various embodiments, the attribute analyzer 404 may operate to identify one or more predictive attributes from a set of attributes corresponding to a set of transactions. In many embodiments, the one or more predictive attributes may include one or more attributes in the set of attributes that are determined to be indicative of transactions that include a particular label. For example, a user may identify a target label for a set of transactions having a set of attributes. The attribute engine 422 may communicate the target label and the set of transactions having the set of attributes to the attribute analyzer 404 as inputs 430a. In response, the attribute analyzer 404 may utilize ML model trainer 412 and/or one or more ML models 434a, 434b, 434c (collectively referred to as ML models 434) to determine attributes in the set of attributes that are indicative of transactions in the set of transactions that include the target label. For example, if a portion of a set of transactions are labeled as fraudulent, the ML model trainer 412 of attribute analyzer 404 may train an ML model (e.g., ML model 434b) against the available attributes in the attribute set. The ML model 434b may then be utilized to identify predictive attributes in the set of attributes for the target label. As will be described in more detail below, in some embodiments, the ML model may comprise a decision tree or random forest model.

The predictive attributes may be returned to attribute engine 422 as outputs 430b and then be communicated to the user via outputs 426b to user interface administrator 408. In some embodiments, a prediction utility score may be determined for each of the attributes. The production utility score may be utilized to rank the attributes and identify one or more attributes with the top prediction utility scores. For example, attribute engine 422 may apply a threshold to the prediction utility scores and only present attributes with prediction utility scores above the threshold to the user for selection. In another example, the attribute engine 422 may present a threshold number of attributes having the highest prediction utility scores. In many embodiments, predictive attributes may be presented via a GUI for selection of one or more to base generation of the transaction processing rule on (see e.g., GUI element 506d of GUI view 504 in FIG. 5.

The set of attributes for a transactions may include various information related to a transaction, such as outcomes, processes, rules, and identifying information associated with a transaction. For example, attributes may include one or more of the following: a charge identifier, a transaction identifier, a parent transaction identifier, a transaction type, timestamps for various operations, a payment method type, a merchant identifier, a platform identifier, a destination identifier, a live mode indicator, an event creation timestamp, an event version, a charge creation timestamp, a computed/predicted outcome, bank identification number (BIN), a refund identifier, a refund visibility, a refund reason, a dispute identifier, a dispute visibility, a dispute reason, an early fraud warning indicator, a fraud analysis outcome, a fraud analysis performance indicator, a gateway outcome, a gateway outcome reason, a blocking reason, authentication indicator, transaction details, user details (e.g., email address, street address, IP address, etc.), metadata details, rules applied, analyses performed, amount of time one or more attributes have been known (e.g., time since first seeing an identifier associated with a transaction, such as an email address) and the like. Additionally, attributes may have various types of values, such as numerical, alphanumeric, structured, unstructured, categorical, Boolean, and the like.

In various embodiments, one or more attributes may correspond to a threshold amount of time. For example, a first attribute may include declined charges per email daily (e.g., last 24-hours) and a second attribute may include declined charges per email weekly (e.g., last 7 days). More generally, in some embodiments, the attributes may include one or more of blocked charges per email for a threshold amount of time (e.g., hourly), total charges per IP address for a threshold amount of time (e.g., weekly), name count for card for a threshold amount of time (e.g., all time), email count for IP address for a threshold amount of time (e.g., hourly), authorizations per customer for a threshold amount of time (e.g., hourly), declined charges per email for a threshold amount of time (e.g., daily), authorized charges per email for a threshold amount of time (e.g., hourly), declined charges per email for a threshold amount of time (e.g., weekly), prior fraud with card for a threshold amount of time (e.g., all time), and total charges with card for a threshold amount of time (e.g., daily). In some embodiments, the attribute values may correspond to all transactions or a subset of transactions (e.g., transactions with a particular merchant).

Once the predictive attributes have been selected, the rule creator 420 and/or attribute engine 422 may generate one or more inputs 432a and receive one or more outputs 432b from rule evaluator 406 to determine various performance characteristics of values and/or ranges of values of the a first selected predictive attribute. The performance characteristics determined by the rule evaluator 406 may be presented to the user to assist the user in determining which values or ranges of values to utilized in generating the transaction processing rule (see e.g., GUI view 604 in FIG. 6). This process may be repeated for each of the selected predictive attributes. After values have been determined for each of the selected predictive attributes, the rule creator 420 may generate a heuristic transaction processing rule based on the selected predictive attributes and the selected values for the selected predictive attributes. In various embodiments, the generated heuristic transaction processing rule may block and/or unblock transactions. For example, if an existing rule allows a transaction, the transaction processing rule may determine to block that transaction. In another example, if an existing rule blocks a transaction, the transaction processing rule may determine to allow that transactions. In many embodiments, performance characteristics of the generated heuristic transaction processing rule may also be determined and presented to the user. If the performance of the transaction processing rule is accepted by the user, the rule implementer 424 may be utilized to implement the transaction processing rule for blocking and/or unblocking future transactions.

More generally, the rule evaluator 406 may include a performance analyzer 416 and an analytics engine 418 that operate to analyze performance of a predictive attributes and transaction processing rules, such as predictive attributes determined by attribute analyzer 404 and/or a transaction processing rule generated by rule creator 420. The performance analyzer 416 of rule evaluator 406 may support testing of predictive attributes and/or predictive transaction processing rules, such as on historical transactions (e.g., the previous 6 months of transactions) and/or the set of transactions being utilized to generate the rule. In various embodiments, the range of the historical transactions may be determined based on user input (e.g., a selection of 2, 4, 6, 8, 10, or 12 months).

Additionally, the analytics engine 418 of rule evaluator 210 may determine various metrics that characterize performance of a transaction processing rule. For example, the performance analyzer 416 may determine blocked transactions, unblocked transactions, previously blocked transactions, previously unblocked (i.e., allowed) transactions, previously allowed but identified as suspicious transactions, and the like. The previously allowed but identified as suspicious transactions may correspond to transactions that were flagged as suspicious (e.g., an early fraud warning) when originally processed by a previously existing rule. The analytics engine 418 may determine performance metrics for attributes and transaction processing rules, such as based on the output of performance analyzer 416. For example, analytics engine 418 may determine one or more of blocking rates, a number of false positives, false positive rates, various percentages, various transaction counts, and the like. Blocking rates may include a number of blocked transactions divided by the total number of transactions in the set of transactions. False positives may correspond to legitimate transactions that are blocked by the transaction processing rule or illegitimate transactions that are unblocked by the transaction processing rule. False positive rates may include the number of transactions with non-target labels that were blocked (or unblocked) divided by the total number of blocked (or unblocked) transactions. In another example, analytics engine 418 may determine a monetary value and/or number of transactions in one or more sets of transactions determined by the performance analyzer 416 or analytics engine 418 (e.g., a value of the blocked transactions determined to be false positives).

An example embodiment using a random forest model for determining predictive attributes and/or generating rules will now be described in more detail. In various embodiments, the random forest model may allow the system to understand which features have the highest “importance” in the training data, and then a subset of features can be selected for rule generation using this “importance” information.

Generally, an attribute may be a feature that can be used for rule writing. A candidate threshold may be a value used to generate a rule. A predicate may be a comparison between an attribute and a threshold. A rule may be one or more predicates evaluated against an input. A hyperparameter may be a number of value that determined the architecture for a model.

Rule predicates may be functions that test some condition of their arguments. In an example embodiment, the arguments considered include all the features of the training data but also include one or more hyperparameters, and the random forest model is built to predict transaction fraud using all possible combinations of these features with all possible functions, using a variety of hyperparameter values. In a transaction system, for example, a predicate may determine, for example, a number of fraudulent transactions from a particular location and compare that number to a threshold value. The threshold value in this case would be a hyperparameter and the number of fraudulent transactions from a particular location is a feature of the training data.

The random forest model may then be built to predict the particular outcome (e.g., outcome associated with the one or more target labels, such as fraud) using the rule attributes as features. The building may involve training the random forest model with the training data, and varying the hyperparameters and iterating until an acceptable area under the curve (AUC) is achieved for the particular entity (e.g., merchant) or group of entities (e.g., group of merchants). This can improve upon decision tree approaches, which may overfit on one particular feature due to a large entropy gain.

A random forest model may operate by creating many trees, with each tree having some randomness built into it. The random forest model is then able to arrive at a decision by utilizing all of the predictions made by the many trees. For a classification task, the output of the random forest is, for example, the class selected by the most trees. For regression tasks, the mean or average prediction of the trees is returned.

In the following description, the target label may be directed to fraudulent transactions. However, it will be appreciated that target labels directed to other outcomes may be utilized without departing from the scope of this disclosure. For example, the techniques can be used for other types of fraud, other than merely transaction fraud, such as merchant fraud (fraud where the merchant is committing the fraud rather than the purchaser). Furthermore, other models can benefit from the above techniques, such as a model to predict a likelihood that a payment method, such as a credit card, will be validated.

Consider the random forest as a collection of trees and at each tree a decision will be made based on the attribute. For instance, at the root of the forest may be a tree which asks, “was the transaction a Visa® credit card transaction?” If yes, then a “yes” branch is followed and if no, then the other branch is followed. Consider in this example the answer is, “yes, the transaction is a Visa credit card transaction,” and so the processing follows the “yes” branch to the right and encounters another decision point, asking “was this card utilized more than four times in the past 24 hours?” Again, if the answer is yes, then the yes branch is followed and if the answer is no, then the no branch is followed. Eventually, after asking a multitude of such questions, processing ends up at a leaf which consists of all sample or past charges matching the same series of predicates. For instance, the sample may be a sub-set of past data or the entirety of past transaction data for a given range, etc. Regardless, at that leaf, the system may determine that out of 100 samples present at that leaf, 80 of the charges were not deemed fraudulent, and 20 were determined to be fraudulent. With this information, the system generates a fraud likelihood score.

However, in order to determine what attribute contributes most to that resulting fraud likelihood score, the system takes both paths for the question “was the transaction a Visa credit card transaction?” Therefore, rather than taking the “yes” branch, both branches are followed as if it were unknown whether the transaction was a Visa credit card transaction. Then, both branches are followed to the terminal leaf where a fraud likelihood score may then be established for each path, both the “yes” and the “no,” for the transaction's total collection of attributes, without knowing whether or not the transaction was a Visa credit card transaction. The resulting fraud likelihood scores are then compared to determine their difference. A small difference may indicate that the branding of this transaction was not a large contributor to the score, whereas a large difference may indicate that the card branding (e.g., Visa or otherwise) was a significant contributor. Next, both branches are followed for the other remaining attributes. For instance, both the yes and no branches may be followed by the question, “was this card utilized more than four times in the past 24 hours?”

At the end of the processing, rather than having a single terminal leaf to generate the fraud likelihood score, a collection of leaves is obtained and then aggregated over all the leaves (for example fifty total leaves collected), with attributes that, when omitted, result in a greatest difference in the resulting fraud likelihood score. For example, when omitting the Visa branding from the analysis results in half the leaves being score fraudulent and half the leaves being scored not fraudulent. Consequently, it may be observed that the branding of the card, Visa or otherwise, is not an indicator of fraud. Rather, the attribute that, when omitted, maximizes the difference between the original score and a new non-determinate evaluated score, when that feature is omitted, may thus be considered to be a large contributor to the resulting fraud likelihood score, or the resulting allowance of the transaction as non-fraudulent, depending on whether the inquiry is one of “why was this transaction rejected” or “why was this transaction allowed.” In such a way, the identification of the attribute or feature which makes the biggest difference in the value of the score may be deemed the “most important” attribute or feature. Indeed, the difference itself can be considered a measure of “importance” of the feature, allowing ranking and other comparisons among the features.

As such, in an example embodiment, a classifier of the random forest model is used to calculate feature importance for all features in the training data, such as by using the difference in the value of the score.

In an example embodiment, the importance scores for the features are used to identify the N most important features in the training set, meaning the N features with the highest importance scores. In an example embodiment, N is set at 25.

Once this set of N most important features is identified, this set may be presented to a user for selection of one or more of the features to use to generate rules. Generation of rules and determination of thresholds may be accomplished in a number of different ways. In an example embodiment, a quantile technique is utilized. In a quantile technique, for each of the N most important features, a set of quantiles are identified, such as the 25th percentile, 50th percentile, 75th percentile, 90th percentile, and 99th percentile. The values for the features at each of these percentile thresholds is determined. Thus, for example, if one of the features is number of transactions for a user, this technique would rank all the users based on their number of transactions, and then identify the number of transactions of the users who were a quarter of the way up that list, halfway up that list, ¾ of the way up that list, 90% up that list, and 99% up that list. Each of those values may then be used as the candidate thresholds (e.g., initial values in attribute value range 612). The candidate thresholds may be accepted and/or adjusted based on user input. The generated rules include the rule predicates in various combinations with each other and also with the various selected thresholds.

In an example embodiment, a maximum number of combinations of rule predicates may be established (e.g., based on user input) and utilized for the rule generation process, to eliminate rules that are likely to simply be too narrow. Thus, for example, assume training data with over 300 different features of transactions. The random forest model may identify the 25 most important of these features.

The rule creator 420 may be set with predicates based on user input selecting predictive attributes. Thus, the rule creator may then generate one or more rules that include predicates involving the selected predictive attributes. Further, the hyperparameters for the rules may include values for each of the quantiles for comparison with each such feature.

Thus, one example rule generated might be that the number of transactions for the user is less than whatever the value is of the user's data 25% of the way up the number of transactions list, along with the value of the transaction, less than whatever value is of the user's data 25% of the way up the transaction value list. Another rule might be that same rule, with a slight variation in the hyperparameters, such that if the number of transactions for the user is less than whatever the value is of the user's data 25% of the way up the number of transactions list, along with the value of the transaction less than whatever value is of the user's data 50% of the way up the transaction value list. All of the quintiles may be used to generate different combinations of this rule, and then various combinations of the selected attributes may be used to create other rules, with their own different combinations of quintiles, including combinations of rules up from one to three predicates combined. These rules may be evaluated, such as via rule evaluator 406.

More generally, the machine learning algorithm may also be selected from among many other different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In another example embodiment, rather than a quantile technique, decision tree algorithm, a boosted tree algorithm or a recursively partitioned tree algorithm can be used for the rule generation process. Using one of these techniques, no quantiles are specified, a decision tree can be built on just the data from the top N features, and the most optimal partition of this decision tree can be identified. Pruning can then be used to control the depth of the tree, which in effect controls how many predicates the rules have. A similar technique can be used with a boosted tree. In a boosted tree embodiment, the concept is that one tree is used, an error is measured, and then the next tree is built trying to address that error.

FIG. 5 illustrates various aspects of an exemplary GUI view 504 for configuring parameters for transaction processing rule generation according to some embodiments. The illustrated embodiment includes a merchant device 502 displaying GUI view 504. The GUI view 504 results in an improved user interface for electronic devices at least through the specific manners of providing (e.g., by displaying) an interactive experience that facilitates generation, testing, and/or implementation of customized transactions processing rules in an intuitive and efficient manner that determines and presents relevant information and functionalities to users, as described in more detail below. For example, the GUI view 504 may provide a specific improvement over existing systems by displaying top predictive attributes with relevant metrics along with other relevant data to assist a user in selecting attributes to use in generating a transaction processing rule tailored to a scenario faced by an entity, such as a merchant. The data presented in GUI view 504 may be generated by one or more components of a TPR generator disclosed and described hereby. It will be appreciated that one or more components of FIG. 5 may be the same or similar to one or more other components disclosed herein. For example, merchant device 502 may be the same or similar to merchant device 116 and/or merchant device 216. Further, aspects discussed with respect to various components in FIG. 5 may be implemented by one or more other components from one or more other embodiments without departing from the scope of this disclosure. Embodiments are not limited in this context.

Referring to FIG. 5, GUI view 504 includes a plurality of GUI elements 506a, 506b, 506c, 506d (collectively referred to as GUI elements 506), a settings icon 514, a back icon 516a, and an accept icon 516b. The settings icon 514 may be selected to adjust one or more settings, parameters, or configurations of the GUI or the TPR generator. The back icon 516a may be selected to return to a previous screen, such as a GUI for labeling and grouping transactions and/or importing user-defined attributes. The accept icon 516b may be selected to proceed to the next step of generating the transaction processing rule (e.g., GUI view 604 of FIG. 6).

The GUI elements 506 display various information, such as information relevant for configuring the TPR generator for creating a transaction processing rule. As shown in the illustrated embodiment, the GUI element 506a indicates the user and/or the merchant. The GUI element 506b includes one or more transaction sets 508a, 508b, 508c (collectively referred to as transactions sets 508). The GUI element 506b enables one or more of these transactions sets 508 to be selected by the user for basing generation of a transaction processing rule on. In various embodiments, these transaction sets may be generated automatically and/or based on user input, such as via transaction metadata controller 302. In the illustrated embodiment, transaction set 508a and transaction set 508c are selected.

The GUI element 506c includes one or more labels 510a, 510b, 510c (collectively referred to as labels 510). The GUI element 506c enables one or more of the labels 510 to be selected (as target labels and/or non-target labels) by the user for basing generation of a transaction processing rule on. In various embodiments, one or more of these labels may be generated automatically and/or based on user input, such as via transaction metadata controller 302. In the illustrated embodiment, label 510b is selected as a target label and label 510c is selected as a non-target label. However, in various embodiments, selection of a non-target label may not be required. For example, any labels not selected as the target label may be treated as non-target labels.

The GUI element 506c includes one or more top predictive attributes. In the illustrated embodiment, the one or more top predictive attributes include attributes 512a, 512b, 512c (collectively referred to as attributes 512). Additionally, the GUI element 506c includes data regarding each of the attributes. For example, each of the attributes 512 may include a description, a predictive utility value, and a type (e.g., Boolean, value, value range). In the illustrated embodiment, attribute 512a and attribute 512b are selected as the predictive attributes upon which to base generation of the transaction processing rule. In many embodiments, GUI element 506d may be populated or updated based on selections in GUI element 506b and GUI element 506c. Once a user is satisfied with the selections, they may click accept icon 516b to proceed to the next step of the transaction processing rule generation procedure to select values or value ranges for the selected predictive attributes (see e.g., GUI view 604 of FIG. 6).

FIG. 6 illustrates various aspects of an exemplary GUI view 604 for configuring attribute values for a transaction processing rule according to some embodiments. The illustrated embodiment includes a merchant device 602 displaying GUI view 604. The GUI view 604 results in an improved user interface for electronic devices at least through the specific manners of providing (e.g., by displaying) an interactive experience that facilitates generation, testing, and/or implementation of customized transactions processing rules in an intuitive and efficient manner that determines and presents relevant information and functionalities to users, as described in more detail below. For example, the GUI view 604 may provide a specific improvement over existing systems by providing an interactive user interface with relevant metrics and data to assist a user in selecting values for a predictive attribute to be utilized in a transaction processing rule tailored to a scenario faced by an entity, such as a merchant. The data presented in GUI view 604 may be generated by one or more components of a TPR generator disclosed and described hereby. It will be appreciated that one or more components of FIG. 6 may be the same or similar to one or more other components disclosed herein. For example, merchant device 602 may be the same or similar to merchant device 116, merchant device 216, and/or merchant device 502. Further, aspects discussed with respect to various components in FIG. 6 may be implemented by one or more other components from one or more other embodiments without departing from the scope of this disclosure. Embodiments are not limited in this context.

Referring to FIG. 6, GUI view 604 includes a plurality of GUI elements 606a, 606b, 618, 620, a target label chart 608, a non-target label chart 610, an attribute value range 612, a settings icon 624, a back icon 626a, and an accept icon 626b. The settings icon 624 may be selected to adjust one or more settings, parameters, or configurations of the GUI or the TPR generator. The back icon 626a may be selected to return to a previous screen, such as GUI view 504. The accept icon 516b may be selected to proceed to the next step of generating the transaction processing rule, such as selection of the values for the next selected predictive attribute.

The GUI elements 606a, 606b display various information relevant to creating a transaction processing rule. As shown in the illustrated embodiment, the GUI element 606a indicates the target labels and the non-target labels. The GUI element 606b includes the current attribute for which values are being selected and the currently selected values. The target label chart 608 displays blocked (or unblocked) target label transactions over the attribute value range 612. Similarly, the non-target label chart 610 displays blocked (or unblocked) non-target label transactions over the attribute value range 612. In various embodiments, the data for these charts may be based on data generated by a rule evaluator (e.g., performance analyzer 416 of rule evaluator 406). In various such embodiments, a user interface administrator may utilize the data generated by the rule evaluator to produce data that configures the GUI view 604 to display target label chart 608 and non-target label chart 610. Additionally, the attribute value range 612 includes a selected range 614 with lower limit slider 616a and upper limit slider 616b. In various embodiments, users may select values for an attribute by adjusting the position of the lower limit slider 616a and upper limit slider 616b.

The GUI element 618 displays information corresponding to the currently selected values for the current attribute. In the illustrated embodiment, the GUI element 618 includes a target label block rate and a false positive rate. In various embodiments, the values may be generated by a rule evaluator. The GUI element 620 includes historical performance data for the currently selected values of the current attribute. The GUI element 620 includes GUI elements 622a, 622b, 622c, GUI element 622d (collectively referred to as GUI elements 622). Each of the GUI elements 622 may include relevant information on the performance characteristics of the currently selected values for the current attribute for various transactions groupings. Each of the GUI elements 622 may include the number blocked, the value of the blocked transactions, and a chart illustrating blocked transactions belonging to the grouping over a historical time period (e.g., the previous 6 months). In the illustrated embodiment, the GUI element 622a corresponds to target label transactions, the GUI element 622b corresponds to non-target label transactions, the GUI element 622c corresponds to transactions flagged with an early fraud warning when originally processed, and GUI element 622d corresponds to transactions already blocked when originally processed.

In many embodiments, once a user is satisfied with the performance characteristics of the selected attribute values for the current attribute, they may select the accept icon 626b to proceed to the next selected attribute for selection of corresponding values. Once values have been selected for all selected attributes, the TPR generator may create a transactions processing rules based on the selections and similar information may be presented in another GUI view for the overall performance characteristics of the transaction processing rule. Further, the users may provide input that causes the transaction processing rule to be implemented (e.g., via accept icon 626b) or the user may return to one or more prior steps to reconfigure aspects of the transaction processing rule (e.g., via back icon 626a).

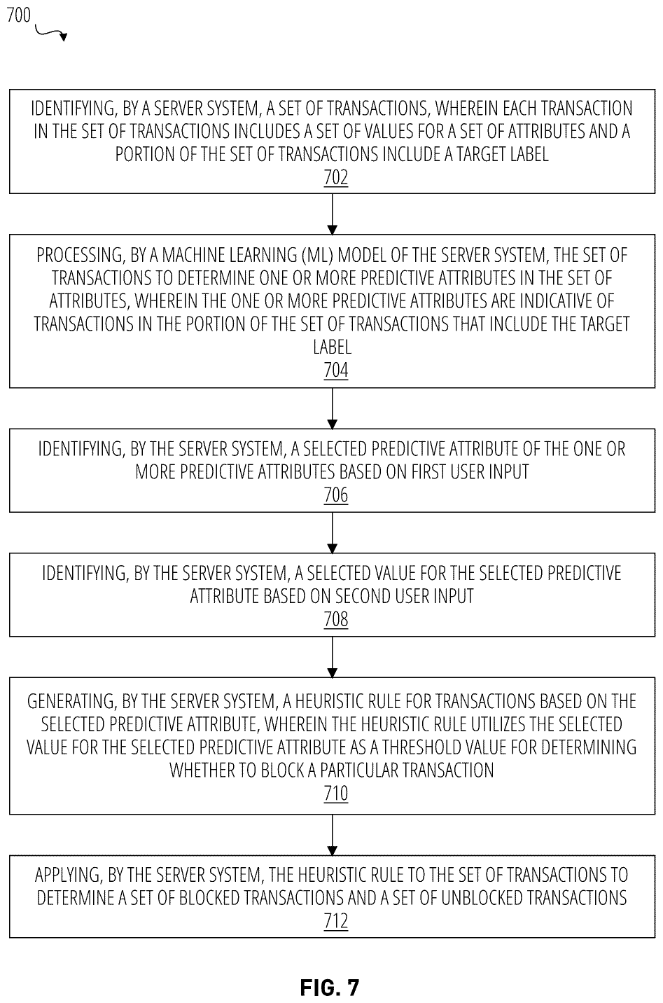

FIG. 7 illustrates a logic flow 700 of a method for generating transaction processing rules according to some embodiments. The logic flow 700 is performed by processing logic that may comprise hardware (circuitry, dedicated logic, etc.), software (such as is run on a general purpose computer system or a dedicated machine), firmware, or a combination. In various embodiments, the logic flow 700 is performed by one or more of a commerce platform system (e.g., commerce platform system 104), a server system (e.g., server system 110 or server system 200), and a TPR generator (e.g., TPR generator 114). Embodiments are not limited in this context.

Referring to FIG. 7, the logic flow 700 begins at block 702. At block 702, a set of transactions may be identifying by a server system. Each transaction in the set of transactions may include a set of values for a set of attributes and a portion of the set of transaction may include a target label. For example, TPR generator 202 may identify a set of transactions retrieved from transaction data store 222 via transaction data interface 214. In various embodiments, the set of transaction may be retrieved in response to input received from a user device, such as merchant device 216. In various embodiments, the input may include user input received via GUI 218 of merchant device 216. For example, the set of transaction may be identified and/or retrieved in response to a user associated with a merchant providing login credentials. In another example, a set of transactions may be retrieved and/or identified in response to input indicating the set of transactions are to be utilized to generate a transaction processing rule. In some such examples, the set of transaction may be created, such as via transaction set manager 316 of transaction metadata controller 302, from a larger set of transaction associated with the merchant.

Continuing to block 704, the set of transactions may be processed by a ML model of the server system to determine one or more predictive attributes in the set of attributes. The one or more predictive attributes may be indicative of transactions in the portion of the set of transactions that include the target label. For example, the attribute engine 422 of rule generator 402 may cause attribute analyzer 404 to utilize one or more of ML models 434 to process the set of transactions to identify one or more predictive attributes. In some embodiments, the ML model trainer 412 may generate one or more of the ML models 434 based on the set of transactions. In many embodiments, the one or more predictive attributes may be presented to a user via a GUI. For example, the top predictive attributes may be presented to a user via GUI element 506d of GUI view 504. In many such examples, a TPR generator (e.g., TPR generator 202) may utilize a user interface administrator (e.g., user interface administrator 212) to generate and transmit data to merchant device 502 that configures the GUI of GUI view 504 to render information based on the one or more predictive attributes.

Proceeding to block 706, a selected predictive attribute may be identified by the server system based on first user input. For example, a user may utilize merchant device 502 to indicate a selected predictive attribute from the top predictive attributes in GUI element 506d of GUI view 504. In such examples, the server system 200 may identify the selected predictive attribute based on the indication from the user received via user interface administrator 212. At block 708, a selected value for the selected predictive attribute may be identified by the server system. For example, a user may utilize merchant device 602 to indicate a selected value for the selected predictive attribute via attribute value range 612 of GUI view 604. In such examples, the server system 200 may identify the selected value for the selected predictive attribute based on the indication from the user received via user interface administrator 212.

At block 710, the server system may generate a heuristic rule for transactions based on the selected predictive attribute. The heuristic rule may utilize the selected value for the selected predictive attribute as a threshold value for determining whether to block a particular transaction. For example, rule creator 420 may generate a heuristic rule for transactions based on a selected predictive attribute identified based on input received via user interface administrator 408. In many such examples, the heuristic rule generated by rule creator 420 may utilize a selected value for the selected predictive attribute identified based on input received via user interface administrator 408.

Continuing to block 712, the server system may apply the heuristic rule to the set of transactions to determine a set of blocked transactions and a set of unblocked transactions. For example, performance analyzer 416 of rule evaluator 406 may apply a heuristic rule generated by rule generator 402 to a set of transactions to determine a set of blocked transactions and a set of unblocked transactions. In many embodiments, the set of blocked transactions and the set of unblocked transactions, or data based thereon, may be presented to a user, such as in GUI view 604. In many such embodiments, this information may be utilized by the user to determine whether performance of the heuristic rule is acceptable. Data based on the set of blocked transactions and the set of unblocked transactions may include various metrics determined from the set of blocked transactions and the set of unblocked transactions, such as target label block rate and false positive rate of GUI element 618 in GUI view 604. In various embodiments, one or more of the various metrics may be determined by analytics engine 418 of rule evaluator 406.

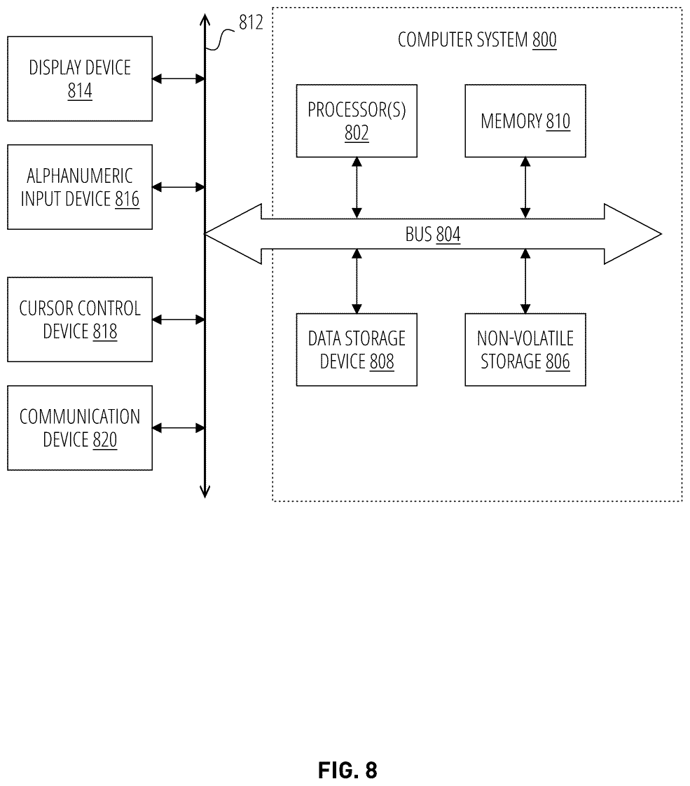

FIG. 8 is one embodiment of a computer system that may be used to support the systems and operations discussed herein. For example, the computer system illustrated in FIG. 8 may be used by a commerce platform system, a server system, a transaction data pipeline, a merchant development system, user system, etc. It will be apparent to those of ordinary skill in the art, however that other alternative systems of various system architectures may also be used.

The data processing system illustrated in FIG. 8 includes a bus or other internal communication means 804 for communicating information, and one or more processors 802 coupled to the bus 804 for processing information. The system further comprises a random access memory (RAM) or other volatile storage device (referred to as memory 810), coupled to bus 804 for storing information and instructions to be executed by processor 802. Memory 810 (e.g., main memory) also may be used for storing temporary variables or other intermediate information during execution of instructions by processor 802. The system also comprises non-volatile storage 806 (e.g., read only memory (ROM) and/or static storage device) coupled to bus 804 for storing static information and instructions for processor 802, and a data storage device 808 such as a magnetic disk or optical disk and its corresponding disk drive. Data storage device 808 is coupled to bus 804 for storing information and instructions.

The system may further be coupled to a display device 814, such as a light emitting diode (LED) display or a liquid crystal display (LCD) coupled to bus 804 through bus 812 for displaying information to a computer user. An alphanumeric input device 816, including alphanumeric and other keys, may also be coupled to bus 804 through bus 812 for communicating information and command selections to processor 802. An additional user input device is cursor control device 818, such as a touchpad, mouse, a trackball, stylus, or cursor direction keys coupled to bus 804 through bus 812 for communicating direction information and command selections to processor 802, and for controlling cursor movement on display device 814.

Another device, which may optionally be coupled to computer system 800, is a communication device 820 for accessing other nodes of a distributed system via a network. The communication device 820 may include any of a number of commercially available networking peripheral devices such as those used for coupling to an Ethernet, token ring, Internet, or wide area network. The communication device 820 may further be a null-modern connection, or any other mechanism that provides connectivity between the computer system 800 and the outside world. Note that any or all of the components of this system illustrated in FIG. 8 and associated hardware may be used in various embodiments as discussed herein.

It will be appreciated by those of ordinary skill in the art that any configuration of the system may be used for various purposes according to the particular implementation. The control logic or software implementing the described embodiments can be stored in memory 810 (e.g., main memory), data storage device 808 (e.g., mass storage device), non-volatile storage 806 (e.g., ROM), or other storage medium locally or remotely accessible to processor 802.

It will be apparent to those of ordinary skill in the art that the system, method, and process described herein can be implemented as software stored in memory 810, non-volatile storage 806, and/or data storage device 808 and executed by processor 802. This control logic or software may also be resident on an article of manufacture comprising a computer readable medium having computer readable program code embodied therein and being readable by the data storage device 808 and for causing the processor 802 to operate in accordance with the methods and teachings herein.

The embodiments discussed herein may also be embodied in a handheld or portable device containing a subset of the computer hardware components described above. For example, the handheld device may be configured to contain only the bus 804, the processor 802, and memory 810 and/or non-volatile storage 806. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 802, a data storage device 808, a bus 804, and memory 810, and only rudimentary communications mechanisms, such as a small touch-screen that permits the user to communicate in a basic manner with the device. In general, the more special-purpose the device is, the fewer of the elements need be present for the device to function.

There are a number of example embodiments described herein.

Example 1 is a computer-implemented method for generating transaction processing rules. The method can include identifying, by a server system, a set of transactions, wherein each transaction in the set of transactions includes a set of values for a set of attributes and a portion of the set of transactions include a target label; processing, by a machine learning (ML) model of the server system, the set of transactions to determine one or more predictive attributes in the set of attributes, wherein the one or more predictive attributes are indicative of transactions in the portion of the set of transactions that include the target label; identifying, by the server system, a selected predictive attribute of the one or more predictive attributes based on first user input; identifying, by the server system, a selected value for the selected predictive attribute based on second user input; generating, by the server system, a heuristic rule for transactions based on the selected predictive attribute, wherein the heuristic rule utilizes the selected value for the selected predictive attribute as a threshold value for determining whether to block a particular transaction; and applying, by the server system, the heuristic rule to the set of transactions to determine a set of blocked transactions and a set of unblocked transactions.

Example 2 is a computer-implemented method of Example 1 that may optionally include transmitting, by the server system via a network, data that configures a graphical user interface to render information based on the set of blocked transaction and the set of unblocked transactions.

Example 3 is a computer-implemented method of Example 1 or 2 that may optionally include that the selected value is identified by the server system based on a position of a slider in the graphical user interface and the slider is movable over a range of potential values for the selected predictive attribute.

Example 4 is a computer-implemented method of any combination of Examples 1-3 that may optionally include determining, by the server system, a false positive rate based on a number of transactions in the set of blocked transactions without the target label; and transmitting, by the server system via a network, data that configures a graphical user interface to render information including the false positive rate.

Example 5 is a computer-implemented method of any combination of Examples 1-4 that may optionally include that the target label is associated with fraudulent transactions.

Example 6 is a computer-implemented method of any combination of Examples 1-5 that may optionally include that the target label is applied to the portion of the set of transactions based on user input.

Example 7 is a computer-implemented method of any combination of Examples 1-6 that may optionally include that the portion of the set of transactions that include the target label include a first portion of the set of transactions and a second portion of the set of transactions include a non-target label wherein the one or more predictive attributes determined by processing the set of transactions by the ML model of the server system are more indicative of transactions in the first portion of the set of transactions that include the target label and less indicative of transactions in the second portion of the set of transactions that include the non-target label.

Example 8 is a computer-implemented method of any combination of Examples 1-7 that may optionally include that the target label is associated with fraudulent transactions and the non-target label is associated with non-fraudulent transactions.

Example 9 is a computer-implemented method of any combination of Examples 1-8 that may optionally include that the set of attributes include a first attribute and a respective value of the first attribute for a respective transaction indicates an amount of time since contact information associated with the respective transaction was first identified by the server system.

Example 10 is a computer-implemented method of any combination of Examples 1-9 that may optionally include that the contact information includes an email address.

Example 11 is a computer-implemented method of any combination of Examples 1-10 that may optionally include that values for a first attribute in the set of attributes include numerical values and values for a second attribute in the set of attributes include Boolean values.

Example 12 is a non-transitory computer readable storage medium including instructions that, when executed by a processor, cause the processor to perform operations for handling card testing attacks according to any combination of Examples 1-11.

Example 13 is a server computer system for handling card testing attacks, comprising: a memory; and a processor coupled to the memory configured to perform operations for handling card testing attacks according to any combination of Examples 1-11.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A computer-implemented method for generating transaction processing rules, the method comprising:
identifying, by a server system, a set of transactions, wherein each transaction in the set of transactions includes a set of values for a set of attributes and a portion of the set of transactions include a target label;
processing, by a machine learning (ML) model of the server system, the set of transactions to determine one or more predictive attributes in the set of attributes, wherein the one or more predictive attributes are indicative of transactions in the portion of the set of transactions that include the target label;
identifying, by the server system, a selected predictive attribute of the one or more predictive attributes based on a first user input;
identifying, by the server system, a selected value for the selected predictive attribute based on a second user input;
generating, by the server system, a heuristic rule for transactions based on the selected predictive attribute, wherein the heuristic rule utilizes the selected value for the selected predictive attribute as a threshold value for determining whether to block a particular transaction; and
applying, by the server system, the heuristic rule to the set of transactions to determine a set of blocked transactions and a set of unblocked transactions.

2. The computer-implemented method of claim 1, further comprising transmitting, by the server system via a network, data that configures a graphical user interface to render information based on the set of blocked transaction and the set of unblocked transactions.

3. The computer-implemented method of claim 2, wherein the selected value is identified by the server system based on a position of a slider in the graphical user interface and the slider is movable over a range of potential values for the selected predictive attribute.

4. The computer-implemented method of claim 1, further comprising:
determining, by the server system, a false positive rate based on a number of transactions in the set of blocked transactions without the target label; and
transmitting, by the server system via a network, data that configures a graphical user interface to render information including the false positive rate.

5. The computer-implemented method of claim 1, wherein the target label is associated with fraudulent transactions.

6. The computer-implemented method of claim 1, wherein the target label is applied to the portion of the set of transactions based on user input.

7. The computer-implemented method of claim 1, wherein the portion of the set of transactions that include the target label include a first portion of the set of transactions and a second portion of the set of transactions include a non-target label wherein the one or more predictive attributes determined by processing the set of transactions by the ML model of the server system are more indicative of transactions in the first portion of the set of transactions that include the target label and less indicative of transactions in the second portion of the set of transactions that include the non-target label.

8. The computer-implemented method of claim 7, wherein the target label is associated with fraudulent transactions and the non-target label is associated with non-fraudulent transactions.

9. The computer-implemented method of claim 1, wherein the set of attributes include a first attribute and a respective value of the first attribute for a respective transaction indicates an amount of time since contact information associated with the respective transaction was first identified by the server system.

10. The computer-implemented method of claim 1, wherein the contact information includes an email address.

11. The computer-implemented method of claim 1, wherein values for a first attribute in the set of attributes include numerical values and values for a second attribute in the set of attributes include Boolean values.

12. A non-transitory computer readable storage medium including instructions that, when executed by a processor, cause the processor to perform operations for generating transaction processing rules, the operations comprising:
identifying, by a server system, a set of transactions, wherein each transaction in the set of transactions includes a set of values for a set of attributes and a portion of the set of transactions include a target label;
processing, by a machine learning (ML) model of the server system, the set of transactions to determine one or more predictive attributes in the set of attributes, wherein the one or more predictive attributes are indicative of transactions in the portion of the set of transactions that include the target label;
identifying, by the server system, a selected predictive attribute of the one or more predictive attributes based on a first user input;
identifying, by the server system, a selected value for the selected predictive attribute based on a second user input;
generating, by the server system, a heuristic rule for transactions based on the selected predictive attribute, wherein the heuristic rule utilizes the selected value for the selected predictive attribute as a threshold value for determining whether to block a particular transaction; and
applying, by the server system, the heuristic rule to the set of transactions to determine a set of blocked transactions and a set of unblocked transactions.

13. The non-transitory computer readable storage medium of claim 12, the operations further comprising transmitting, by the server system via a network, data that configures a graphical user interface to render information based on the set of blocked transaction and the set of unblocked transactions.

14. The non-transitory computer readable storage medium of claim 13, wherein the selected value is identified by the server system based on a position of a slider in the graphical user interface and the slider is movable over a range of potential values for the selected predictive attribute.

15. The non-transitory computer readable storage medium of claim 12, the operations further comprising:
determining, by the server system, a false positive rate based on a number of transactions in the set of blocked transactions without the target label; and
transmitting, by the server system via a network, data that configures a graphical user interface to render information including the false positive rate.

16. The non-transitory computer readable storage medium of claim 12, wherein the portion of the set of transactions that include the target label include a first portion of the set of transactions and a second portion of the set of transactions include a non-target label wherein the one or more predictive attributes determined by processing the set of transactions by the ML model of the server system are more indicative of transactions in the first portion of the set of transactions that include the target label and less indicative of transactions in the second portion of the set of transactions that include the non-target label.

17. A server computer system for generating transaction processing rules, comprising:
a memory; and
a processor coupled to the memory configured to:
identify, by a server system, a set of transactions, wherein each transaction in the set of transactions includes a set of values for a set of attributes and a portion of the set of transactions include a target label;
process, by a machine learning (ML) model of the server system, the set of transactions to determine one or more predictive attributes in the set of attributes, wherein the one or more predictive attributes are indicative of transactions in the portion of the set of transactions that include the target label;
identify, by the server system, a selected predictive attribute of the one or more predictive attributes based on a first user input;
identify, by the server system, a selected value for the selected predictive attribute based on a second user input;
generate, by the server system, a heuristic rule for transactions based on the selected predictive attribute, wherein the heuristic rule utilizes the selected value for the selected predictive attribute as a threshold value for determining whether to block a particular transaction; and
apply, by the server system, the heuristic rule to the set of transactions to determine a set of blocked transactions and a set of unblocked transactions.

18. The server computer system of claim 17, the processor coupled to the memory further configured to:
determine, by the server system, a false positive rate based on a number of transactions in the set of blocked transactions without the target label; and
transmit, by the server system via a network, data that configures a graphical user interface to render information including the false positive rate.

19. The server computer system of claim 17, wherein the portion of the set of transactions that include the target label include a first portion of the set of transactions and a second portion of the set of transactions include a non-target label wherein the one or more predictive attributes determined by processing the set of transactions by the ML model of the server system are more indicative of transactions in the first portion of the set of transactions that include the target label and less indicative of transactions in the second portion of the set of transactions that include the non-target label.

20. The server computer system of claim 17, wherein the set of attributes include a first attribute and a respective value of the first attribute for a respective transaction indicates an amount of time since contact information associated with the respective transaction was first identified by the server system.
